(19) United States
(12) Patent Application Publication
(10) Pub. No.: US 2026/0039062 A1
(43) Pub. Date: Feb. 5, 2026

(54) CONNECTOR ASSEMBLY

(71) Applicant: ADVANCED-CONNECTEK INC., New Taipei City (TW)

(72) Inventors: Shu-Fen Wang, New Taipei City (TW); Kuan-Lin Chen, New Taipei City (TW); Hou-Bin Lin, New Taipei City (TW)

(21) Appl. No.: 19/283,546

(22) Filed: Jul. 29, 2025

(30) Foreign Application Priority Data
Aug. 2, 2024 (TW) 113208356

(51) Int. Cl. H01R 13/6585; H01R 12/79

(52) U.S. Cl. CPC H01R 13/6585; H01R 12/79

(57) ABSTRACT

A connector assembly includes a board-end connector and a cable-end connector. The board-end connector includes an outer shell and an insulated housing, a terminal module, and a conductive body in the outer shell. The outer shell includes a cover plate and a frame opening portion and has first elastic pieces and second elastic pieces. The insulated housing has a receiving cavity and an insertion opening. The terminal module includes ground terminals and pairs of signal terminals. The conductive body includes a main body and third elastic pieces. The main body is connected to the second elastic pieces, and each of the third elastic pieces is connected to a corresponding one of the ground terminals. The cable-end connector includes a flexible parallel cable and a plug, and two surfaces of the flexible parallel cable include grounding conduction portions.

### CROSS-REFERENCE TO RELATED APPLICATION

This non-provisional application claims priority under 35 U.S.C. § 119(a) to Patent Application No. 113208356 filed in Taiwan, R.O.C. on Aug. 2, 2024, the entire contents of which are hereby incorporated by reference.

### FIELD OF THE INVENTION

The instant disclosure relates to a connector, and more particular to a connector assembly.

### BACKGROUND

The connection interfaces in telecommunication industry are developed to be lightweight and tiny and to have stable signal transmissions. For the connection interfaces applied in high speed transmission server and switch, for example, the mini cool edge IO (MCIO) connector, the MCIO connector has a small size plus reliable and stable connection. An MCIO connector known to the inventor includes a board-end connector and a cable-end connector. The cable-end connector comprises a cable, a PCB, and a plug on the PCB. The plug has a plastic core, upper and lower terminals, and a hook member. As a result, the components of the connector is complicated, and thus the manufacturing cost for the connector is high. Moreover, in the manufacturing process of the cable-end connector, the cable has to be welded with the PCB, and the manufacturing process is complicated and difficult.

Moreover, as known to the inventor, the high frequency characteristics of the connector may be improved by configuring a shielding case on the conductive plastic member or the cable; however, the manufacturing process for the shielding case is relatively complicated.

### SUMMARY OF THE INVENTION

In view of these, some embodiments of the instant disclosure provides a connector assembly comprising a board-end connector and a cable-end connector. The board-end connector comprises an outer shell, an insulated housing, a terminal module, and a conductive body. The insulated housing, the terminal module, and the conductive body are in the outer shell. The outer shell comprises a cover plate and a frame opening portion at one side of the cover plate. The outer shell has a plurality of first elastic pieces and a plurality of second elastic pieces. The first elastic pieces extend from two sides of the frame opening portion toward an interior of the frame opening portion, and the second elastic pieces extend from the cover plate toward an interior of the cover plate. The insulated housing has a receiving cavity and an insertion opening in communication with the receiving cavity and corresponding to the frame opening portion. A surface of the insulated housing has a plurality of through holes for receiving the second elastic pieces. The terminal module is in the receiving cavity of the insulated housing, and the terminal module comprises a plurality of ground terminals and a plurality of pairs of signal terminals arranged as a single row along an axial line. The conductive body comprises a main body and a plurality of third elastic pieces. The main body is connected to the second elastic pieces and in the receiving cavity of the insulated housing. Each of the third elastic pieces extends outwards from the main body and is connected to a corresponding one of the ground terminals. The cable-end connector comprises a flexible parallel cable and a plug at one end of the flexible parallel cable, and two surfaces of the flexible parallel cable comprise a plurality of grounding conduction portions. When the plug and the flexible parallel cable of the cable-end connector are inserted into the receiving cavity through the insertion opening, each of the grounding conduction portions contacts a corresponding one of the first elastic pieces to allow an electrical connection among the flexible parallel cable, the outer shell, the conductive body, and the ground terminals to be established.

In some embodiments, each of the ground terminals comprises a first contact portion, a first body portion, and a first tail portion. The first contact portion extends from one of two ends of the first body portion, and the first tail portion extends from the other end of the first body portion. Moreover, each of the signal terminals comprises a second contact portion, a second body portion, and a second tail portion. The second contact portion extends from one of two ends of the second body portion, and the second tail portion extends from the other end of the second body portion.

In some embodiments, the terminal module comprises a terminal base formed with the first body portions of the ground terminals and the second body portions of the signal terminals, and the first tail portions of the ground terminals and the second tail portions of the signal terminals are exposed from the terminal base.

In some embodiments, the terminal base comprises a plurality of convex portions combined with the signal terminals, each of the convex portions covers a corresponding one of the second body portions, and each of the first body portions is exposed from a side portion of a corresponding one of the convex portions and connected to a corresponding one of the third elastic pieces.

In some embodiments, the conductive body comprises a plurality of shielding portions, each of the shielding portions leans against a corresponding one of the convex portions, and each of the third elastic pieces extends from a side portion of a corresponding one of the shielding portions to the side portion of the corresponding one of the convex portions and is connected to the corresponding one of the first body portions.

In some embodiments, the main body of the conductive body is between the terminal module and the cover plate, and the main body is covered over the first contact portions and the second contact portions.

In some embodiments, a skin of the flexible parallel cable comprises a shielding layer, and the shielding layer has a plurality of non-insulated regions. The grounding conduction portions are arranged on the non-insulated regions at the two surfaces of the flexible parallel cable.

In some embodiments, each of the pairs of the signal terminals are between corresponding two of the ground terminals. One surface of the plug comprises a plurality of contacts, and the contacts are configured to be connected to the signal terminals and the ground terminals.

In some embodiments, the number of the signal terminals and the ground terminals

is 37, the number of the signal terminals is 24, and the number of the ground terminals is 13.

In some embodiments, the flexible parallel cable of the cable-end connector is a flexible flat cable, each of the contacts is a flat terminal, a connection line between the contacts is defined as a first axial line, the contacts are arranged along the first axial line and spaced apart from each other, and the contacts at the surface of the plug are arranged into a single row.

According to some embodiments of the instant disclosure, through the structural configuration among the grounding conduction portions of the flexible parallel cable, the first elastic pieces and the second elastic pieces of the outer shell, the ground terminals, and the conductive body, when the plug and the flexible parallel cable of the cable-end connector are inserted into the receiving cavity through the insertion opening, each of the grounding conduction portions contacts a corresponding one of the first elastic pieces to allow an electrical connection among the flexible parallel cable, the outer shell, the conductive body, and the ground terminals to be established. Therefore, a complete loop for grounding can be formed effectively, thereby ensuring that the noises can be grounded properly. Moreover, the conductive body can effectively prevents signal interferences.

### BRIEF DESCRIPTION OF THE DRAWINGS

The instant disclosure will become more fully understood from the detailed description given herein below for illustration only, and thus not limitative of the instant disclosure, wherein:

FIG. 1 illustrates a perspective view of a connector assembly according to some embodiments of the instant disclosure, where a board-end connector and a cable-end connector of the connector assembly are not mated with each other yet;

FIG. 2 illustrates a front exploded view of the board-end connector according to some embodiments of the instant disclosure;

FIG. 3 illustrates a rear exploded view of the board-end connector according to some embodiments of the instant disclosure;

FIG. 4 illustrates a top view of the connector assembly according to some embodiments of the instant disclosure;

FIG. 5 illustrates a bottom view of the connector assembly according to some embodiments of the instant disclosure;

FIG. 6 illustrates a front view of the board-end connector according to some embodiments of the instant disclosure;

FIG. 7 illustrates a cross-sectional view along line 7-7 shown in FIG. 6, where the board-end connector and the cable-end connector of the connector assembly are not mated with each other yet;

FIG. 8 illustrates a cross-sectional view along line 7-7 shown in FIG. 6, where the board-end connector and the cable-end connector of the connector assembly are mated with each other;

FIG. 9 illustrates an enlarged partial cross-sectional view of the board-end connector according to some embodiments of the instant disclosure, showing the connection among the second elastic pieces, the conductive body, and the terminal module;

FIG. 10 illustrates an enlarged partial cross-sectional view of the board-end connector according to some embodiments of the instant disclosure, showing the connection among the conductive body, and the terminal base of the terminal module; and

FIG. 11 illustrates a schematic view showing the grounding condition of the connector assembly according to some embodiments.

### DETAILED DESCRIPTION

Detailed description of the characteristics and the advantages of the instant disclosure are shown in the following embodiments. The technical content and the implementation of the instant disclosure should be readily apparent to any person skilled in the art from the detailed description, and the purposes and the advantages of the instant disclosure should be readily understood by any person skilled in the art with reference to content, claims, and drawings in the instant disclosure.

To illustrate the embodiments of the instant disclosure, in the drawings, the first axis X is the X axis of the Cartesian coordinate, the second axis Y is the Y axis of the Cartesian coordinate, and the third axis is the Z axis of the Cartesian coordinate.

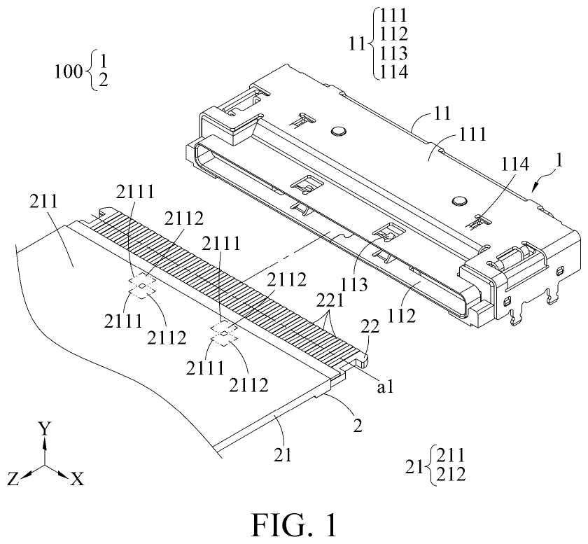

Please refer to FIG. 1. FIG. 1 illustrates a perspective view of a connector assembly 100, where the board-end connector 1 and the cable-end connector 2 of the connector assembly 100 are not mated with each other yet. The connector assembly 100 comprises a board-end connector 1 and a cable-end connector 2. The board-end connector 1 is an elongated connector. The long side of the board-end connector 1 extends along a first axis X direction, the short side of the board-end connector 1 extends along a third axis Z direction, and the height of the board-end connector extends along a second axis Y direction. The signal transmitted by the connector assembly 100 is identical to the signal transmitted by the MCIO connector, while the structure of the connector assembly 100 is different from the structure of the MCIO connector. The cable-end connector 2 is adapted to be applied for a flexible flat cable (FFC). Because the board-end connector 1 is adapted to be mated with the FFC type cable-end connector 2 which is lightweight and tiny, the size of the board-end connector 1 can be reduced relatively.

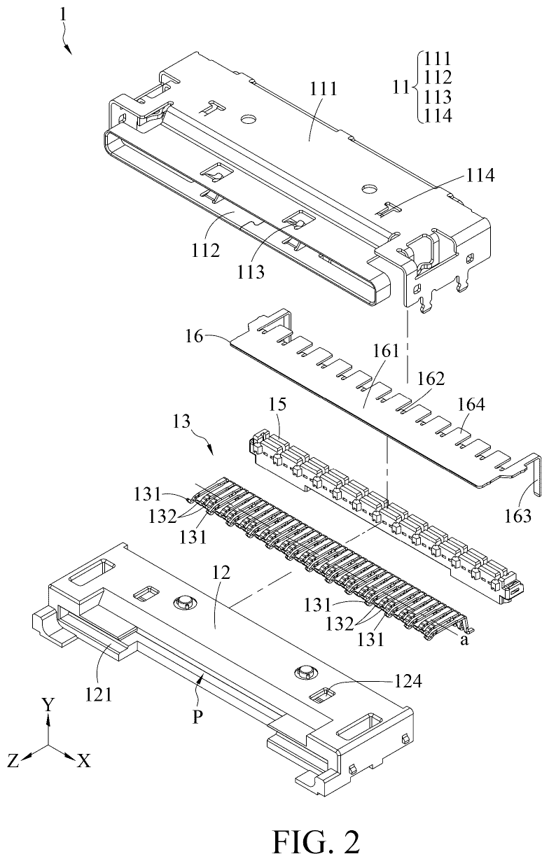

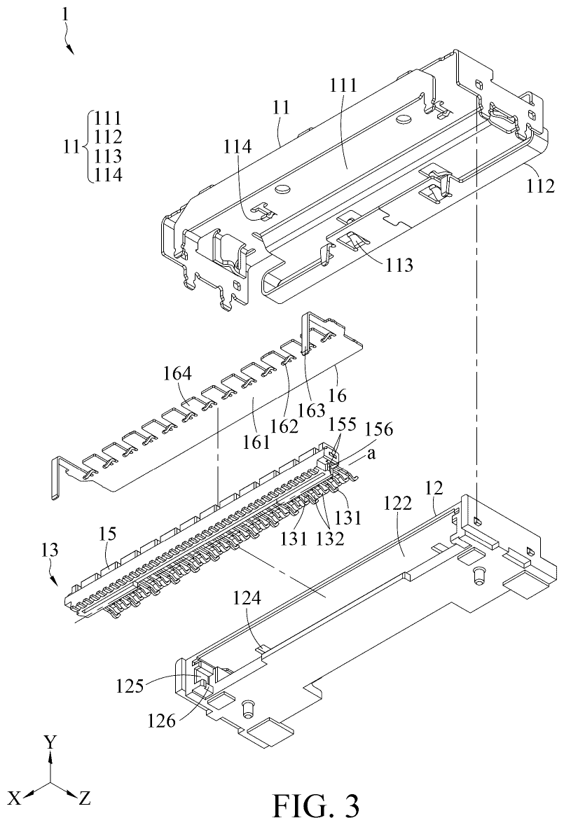

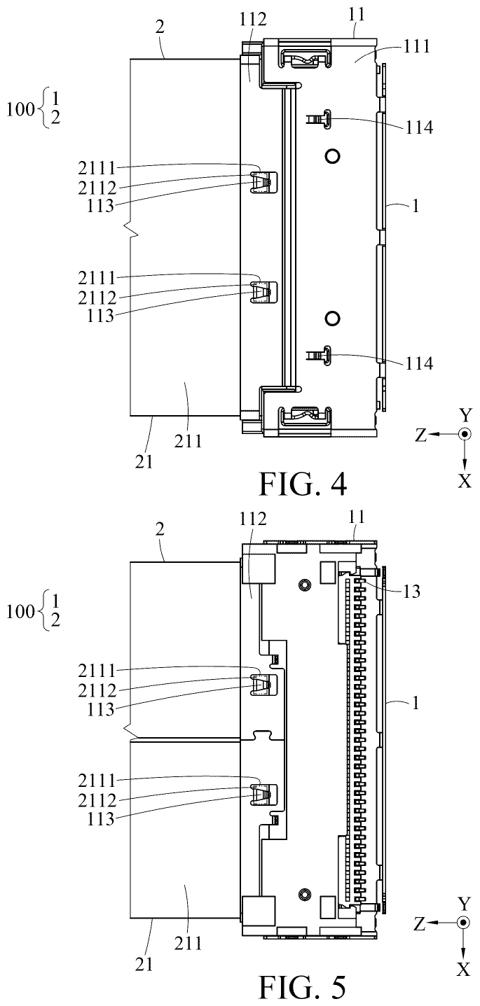

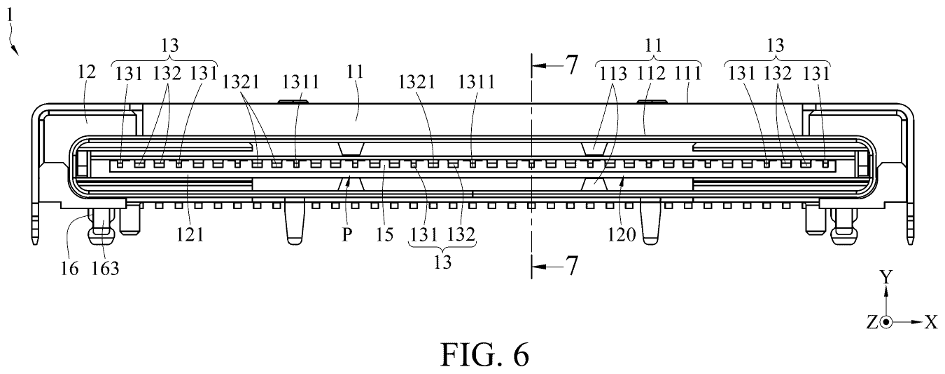

Please refer to FIG. 2 to FIG. 6. FIG. 2 illustrates a front exploded view of the board-end connector 1. FIG. 3 illustrates a rear exploded view of the board-end connector 1. FIG. 4 illustrates a top view of the connector assembly 100. FIG. 5 illustrates a bottom view of the connector assembly 100. FIG. 6 illustrates a front view of the board-end connector 100. The board-end connector 1 comprises an outer shell 11, an insulated housing 12, a terminal module 13, and a conductive body 16. The outer shell 11 comprises a cover plate 111 and a frame opening portion 112 at one side of the cover plate 111. The cover plate 111 is a plate extending along the third axis Z direction, while the frame opening portion 112 is a long and narrow opening extending along the first axis X direction. The outer shell 11 has a plurality of first elastic pieces 113 and a plurality of second elastic pieces 114. The first elastic pieces 113 extend from two sides of the frame opening portion 112 toward an interior of the frame opening portion 112, and the second elastic pieces 114 extend from the cover plate 111 toward an interior of the cover plate 111. In this embodiment, the end portion of each of the elastic pieces (which may be the first elastic pieces 113 and the second elastic pieces 114) is a curved structure.

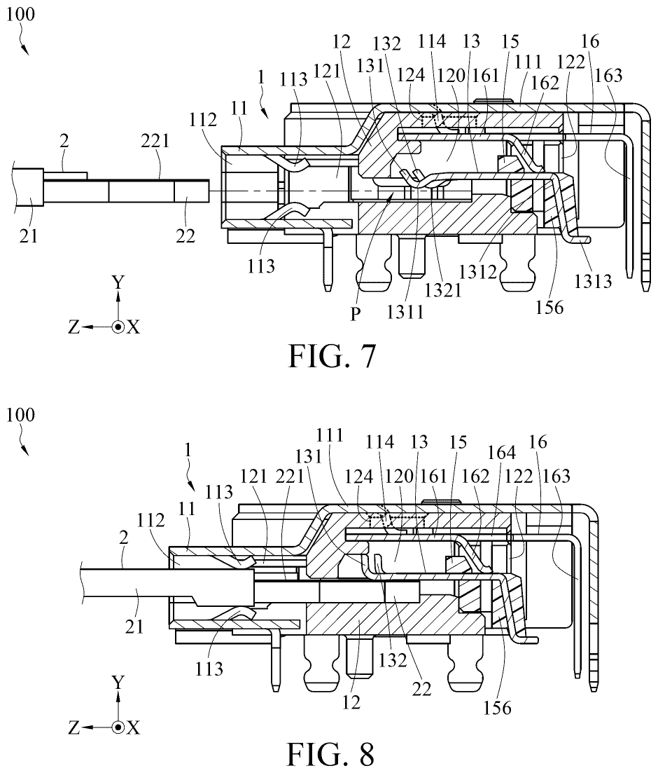

The insulated housing 12 is in the outer shell 11 (as shown in FIG. 7), and the insulated housing 12 has a receiving cavity 120, an insertion opening 121, an assembling opening 122, and a plurality of through holes 124. The insulated housing 12 has a receiving cavity 120, one of two ends of the insulated housing 12 has an insertion opening 121 in communication with the receiving cavity 120, and the other end of the insulated housing 12 has an assembling opening 122 in communication with the receiving cavity 120. The receiving cavity 120, the insertion opening 121, and the assembling opening 122 are together defined through the insulated housing 12 along the third axis Z direction, and the insertion opening 121 and the assembling opening are long and narrow openings extending along the first axis X direction. The insertion opening 121 and the assembling opening 122 are respectively at surfaces of the two end of the insulated housing 12. The through holes 124 are on a surface of the insulated housing 12 for receiving the second elastic pieces 114. In some embodiments, the insulated housing 12 is a hollow rectangular plastic core.

The terminal module 13 is in the receiving cavity 120 of the insulated housing 12, and the terminal module 13 comprises a plurality of ground terminals 131 and a plurality of pairs of signal terminals 132. Each of the signal terminals 132 and the ground terminals 131 is a flexible terminal, each of the ground terminals 131 is a long terminal, each of the signal terminals 132 is a short signal, and the ground terminals 131 and the signal terminals 132 are arranged as a single row along an axial line a (which is identical to the first axis X), as shown in FIG. 2. Each of the ground terminals 131 comprises a first contact portion 1311, each of the signal terminals 132 comprises a second contact portion, and each of the first contact portion 131 and the second contact portion 132 is a curved structure protruding toward a bottom portion of the board-end connector 1 along the second axis Y direction. In some embodiments, the first contact portions 1311 are arranged along the first axis X direction and spaced apart from each other, and the second contact portions 1321 are arranged along the first axis X direction and spaced apart from each other. In some embodiments, each of the pairs of the signal terminals 132 are between corresponding two of the ground terminals 131.

The conductive body 16 is in the receiving cavity 120 of the insulated housing 12, and the conductive body 16 is provided for noise grounding and conduction. The conductive body 16 comprises a main body 161 and a plurality of third elastic pieces 162. The main body 161 is a rectangular plate extending along the first axis X direction. Each of the third elastic pieces 162 is an inclined arm extending outward from a rea portion of the main body 161. In some embodiments, when the main body 161 is assembled in the receiving cavity 120 through the assembling opening 122, the main body 161 is in the receiving cavity 120, on the terminal base 15, and connected to the second elastic pieces 114. Moreover, each of the third elastic pieces 162 is connected to a corresponding one of the ground terminals 131.

The cable-end connector 2 comprises a flexible parallel cable 21 and a plug 22 at one end of the flexible parallel cable 21. Two surfaces of the flexible parallel cable 21 comprise a plurality of grounding conduction portions 2112 (illustrated by dashed-line rectangles), and one surface of the plug 22 comprises a plurality of contacts 221. In some embodiments, the flexible parallel cable 21 is a flexible flat cable (FFC), and the plug 22 is an elongated plate. In some embodiments, each of the contacts 221 is a flat terminal, a connection line between the contacts 221 defines a first axial line al, and the direction of the first axial line al is identical to the first axis X direction. The contacts 221 are arranged along the first axial line al and spaced apart from each other, and the contacts 221 at the surface of the plug 22 are arranged into a single row. Lengths of the contacts 221 along the third axis Z direction are identical to each other, and widths of the contacts along the first axis X direction are identical to each other. In some embodiments, one surface of the plug 22 comprises a plurality of contacts 221, and the contacts 221 are adapted to be connected to the pairs of the signal terminals 132 and the ground terminals 131.

In some embodiments, a skin of the flexible parallel cable 21 comprises a shielding layer 211, and the shielding layer 211 comprises a plurality of non-insulated regions 2111 (as shown in FIG. 1). The non-insulated regions 2111 are regions of the surface of the flexible parallel cable 21 where the insulated coating are removed. Moreover, the grounding conduction portions 2112 are arranged on the non-insulated regions 2111 at the two surfaces of the flexible parallel cable 21.

Please refer to FIG. 4 and FIG. 5. The first elastic pieces 113 at the frame opening portion 112 respectively contact the grounding conduction portions 2112 on the two surfaces of the flexible parallel cable 21, so that the unnecessary noises on the flexible parallel cable 21 can be conducted.

Please refer to FIG. 6. FIG. 6 illustrates a front view of the board-end connector 1

according to some embodiments of the instant disclosure. in some embodiments, upon viewing along the third axis Z direction, the first elastic pieces 113 extend inwards from the surface of the frame opening portion 112. In some embodiments, upon viewing the insertion opening 121 of the insulated housing 12 along the third axis Z direction, the first contact portions 1311 and the second contact portions 1321 are in the receiving cavity 120 and are above the insertion opening 121, and the first contact portions 1311 and the second contact portions 1321 are arranged into a single row along the first axis X direction, but the instant disclosure is not limited thereto. In some embodiments, upon viewing the insertion opening 121 of the insulated housing 12 along the third axis Z direction, the first contact portions 1311 and the second contact portions 1321 are in the receiving cavity 120 and are below the insertion opening 121.

In some embodiments, the number of the ground terminals 131 and the signal terminals 132 is 37, the number of the signal terminals 132 is 24, and the number of the ground terminals 131 is 13. Each of the pairs of the signal terminals 132 are between corresponding two of the ground terminals 131. Upon viewing from FIG. 6 along the third axis Z direction, the arrangement of the terminals is, from left to right, the first terminal is a ground terminal 131, the second and third terminals are a first pair of signal terminals 132, the fourth terminal is a ground terminal 131, the fifth and sixth terminals are a second pair of signal terminals 132, the seventh terminal is a ground terminal 131, vice versa, the thirty-fourth terminal is a ground terminal 131, the thirty-fifth and thirty-sixth terminals are the twelfth pair of signal terminals 132, and the thirty-seventh terminal is a ground terminal 131.

Please refer to FIG. 2 and FIG. 7. FIG. 7 illustrates a cross-sectional view along line 7-7 shown in FIG. 6, where the board-end connector 1 and the cable-end connector 2 of the connector assembly 100 are not mated with each other yet. In some embodiments, each of the ground terminals 131 comprises a first body portion 1312 and a first tail portion 1313 adjacent to the assembling opening 122. For each of the ground terminals 131, the first contact portion 1311 extends outwards from one of two ends of the first body portion 1312 along the third axis Z direction, the first tail portion 1313 extends outwards from the other end of the first body portion 1312 along the third axis Z direction, and the first contact portion 1311 and the first tail portion 1313 are at two ends of the first body portion 1312, respectively. For each of the ground terminals 131, the first contact portion 1311 and the first body portion 1312 are substantially configured to be a mirrored L structure upon viewing from the first axis X direction, and the first body portion 1312 and the first tail portion 1313 are substantially configured to be an L structure upon viewing from the first axis X direction.

In some embodiments, each of the signal terminals 132 comprises a second body portion 1322 and a second tail portion 1323 adjacent to the assembling opening 122. For each of the signal terminals 132, the second contact portion 1321 extends outwards from one of two ends of the second body portion 1322 along the third axis Z direction, the second tail portion 1323 extends outwards from the other end of the second body portion 1322 along the third axis Z direction, and the second contact portion 1321 and the second tail portion 1323 are at two ends of the second body portion 1322, respectively. For each of the signal terminals 132, the second contact portion 1321 and the second body portion 1322 are substantially configured to be a mirrored L structure upon viewing from the first axis X direction, and the second body portion 1322 and the second tail portion 1323 are substantially configured to be an L structure upon viewing from the first axis X direction.

In some embodiments, a thickness of each of the signal terminals 132 is greater than a thickness of the corresponding one of the ground terminals 131, and a second width of the second contact portion 1321 of the signal terminal 132 along the first axis X direction is greater than a first width of the first body portion 1312 of the ground terminal 131 along the first axis X direction. Accordingly, in some embodiments, by configuring the second width of the signal terminal 132 to be greater than the first width of the ground terminal 131, the demands for high frequency signal transmission can achieved.

In some embodiments, the terminal module 13 comprises a terminal base 15. A long side direction of the terminal base 15 extends along the first axis X direction, and a short side direction of the terminal base 15 extends along the third axis Z direction. The terminal base 15 is formed with the first body portions 1312 of the ground terminals 131 and the second body portions 1322 of the signal terminals 132. The first tail portions 1313 of the ground terminals 131 and the second tail portions 1323 of the signal terminals are exposed from the terminal base 15. For example, the terminal base 15 is a rectangular plastic core, the long side direction of the rectangular plastic core extends along the first axis X direction, and the short side direction of the rectangular plastic core extends along the third axis Z direction. Moreover, the terminal base 15 is formed with the first body portions 1312 of the ground terminals 131 and the second body portions 1322 of the signal terminals 132 during the injection molding process. The first contact portions 1311 of the ground terminals 131 and the second contact portions 1321 of the signal terminals 132 are exposed from a front end surface of the terminal base 15, and the first tail portions 1313 of the ground terminals 131 and the second tail portions 1323 of the signal terminals are exposed from a bottom portion of the terminal base 15.

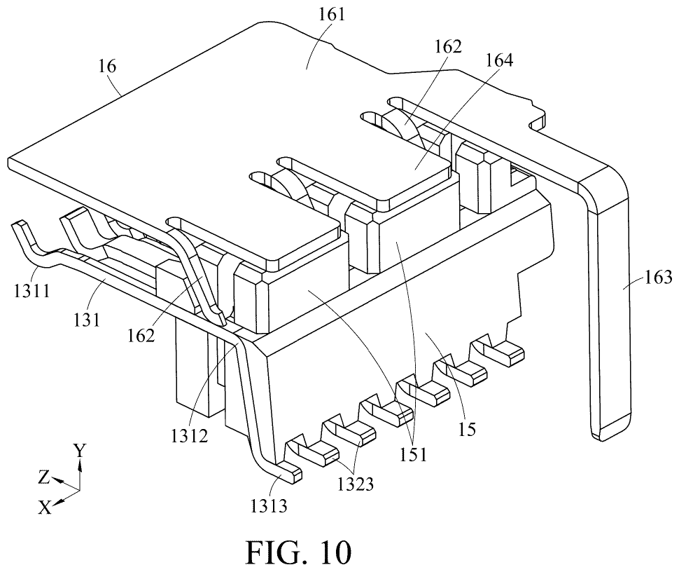

Please refer to FIG. 3 and FIG. 10. FIG. 10 illustrates an enlarged partial cross-sectional view of the board-end connector 1, showing the connection among the conductive body 16, and the terminal base 15 of the terminal module 13. In some embodiments, the terminal base 15 comprises a plurality of convex portions 151 combined with the signal terminals 132, each of the convex portions 151 covers the second body portion 1322 of a corresponding one of the signal terminals 132, and the first body portion 1312 of each of the ground terminals 131 is exposed from a side portion of a corresponding one of the convex portions 151 and connected to a corresponding one of the third elastic pieces 162.

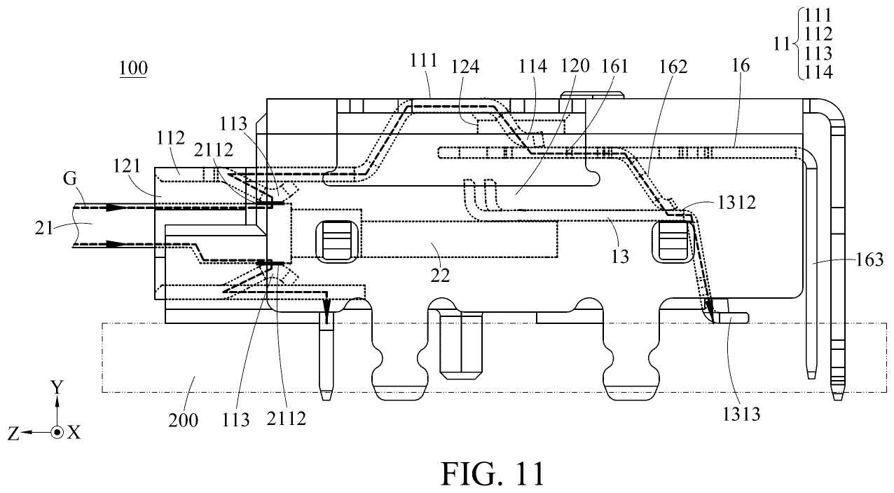

In some embodiments, the conductive body 16 further comprises a plurality of legs 163 and a plurality of shielding portions 164. The legs 163 extend outwards from two sides of the main body 161 along the same direction, and the legs 163 are adapted to be connected to a circuit board 200 (as shown in FIG. 11) for grounding and noise conduction. Each of the shielding portions 164 leans against a corresponding one of the convex portions 151, and each of the third elastic pieces 162 extends from a side portion of a corresponding one of the shielding portions 164 to the side portion of the corresponding one of the convex portions 151 and is connected to the first body portion 1312 of the corresponding one of the ground terminals 131. Moreover, because the conductive body 16 is made of a metallic material, not only the conductive body 16 can guide the noises effectively, but also the shielding portions 164 on the convex portions 151 can provide noise shielding and prevent signal inferences.

Please refer to FIG. 3. In some embodiments, each of two sides of the terminal base 15 comprises a plurality of protrusions 155 and an engaging block 156, and the insulated housing 12 comprises a recessed portion 125 and an engaging groove 126 at each of two sides of an inner wall of the assembling opening 122. When the terminal base 15 is assembled in the assembling opening 122 along the third axis Z direction, each of the protrusions 155 of the terminal base 15 correspondingly contacts an inner wall of a corresponding one of the recessed portions 125, so that the two surfaces at the two sides of the terminal base 15 and the two side walls of the assembling opening 122 in the insulated housing 12 can be positioned with each other in an interference-fit manner, and the movements of the terminal base 15 along the first axis X direction, the second axis Y direction, and the third axis Z direction are limited. When a front inclined surfaces of the engaging block 156 of the terminal base 15 guides the engaging block 156 to be engaged with the engaging groove 126 of the insulated housing 12, a rear stopping surface of the engaging block 156 of the terminal base 15 is limited in the engaging groove 126, so that the terminal base 15 and the insulated housing 12 are combined with each other to limit the movement of the terminal base 15 along the third axis Z direction.

Please refer to FIG. 2 and FIG. 8. FIG. 8 illustrates a cross-sectional view along line 7-7 shown in FIG. 6, where the board-end connector 1 and the cable-end connector 2 of the connector assembly 100 are mated with each other. When the plug 22 of the cable-end connector 2 is inserted into the insertion opening 121 along the third axis Z direction, the plug 22 is inserted into the insertion opening 121 along an insertion path between the insertion opening 121 and the receiving cavity 120. Next, some of the contacts 221 on the surface of the plug 22 (the upper surface of the plug 22 shown in FIG. 1) firstly contact the first contact portions 1311 of the ground terminals 131, so that the first contact portions 1311 are pushed to swing toward a top portion of the receiving cavity 120 along the second axis Y direction. Then, when the plug 22 is further inserted into the receiving cavity 120 of the insulated housing 12 along the third axis Z direction, rest of the contacts 221 on the plug 22 contact the second contact portions 1321 of the signal terminals 132, so that the second contact portions 1321 are pushed to swing toward the top portion of the receiving cavity 120 along the second axis Y direction. Therefore, according to some embodiments, through the configuration that the contacts 221 firstly contact the first contact portions 1311 and then contact the second contact portions 1321, the terminal contact of the ground terminals 131 is achieved firstly for grounding and noise conduction and then the terminal contact of the signal terminals 132 is achieved for signal transmission. Moreover, the first elastic pieces 113 on the frame opening portion 112 respectively contact the grounding conduction portions 221 on the two surfaces of the flexible parallel cable 21, and the first elastic pieces 113 which are configured as L structures and at the upper portion and the lower portion of the frame opening portion 112 provide a clamping force for the flexible parallel cable 21.

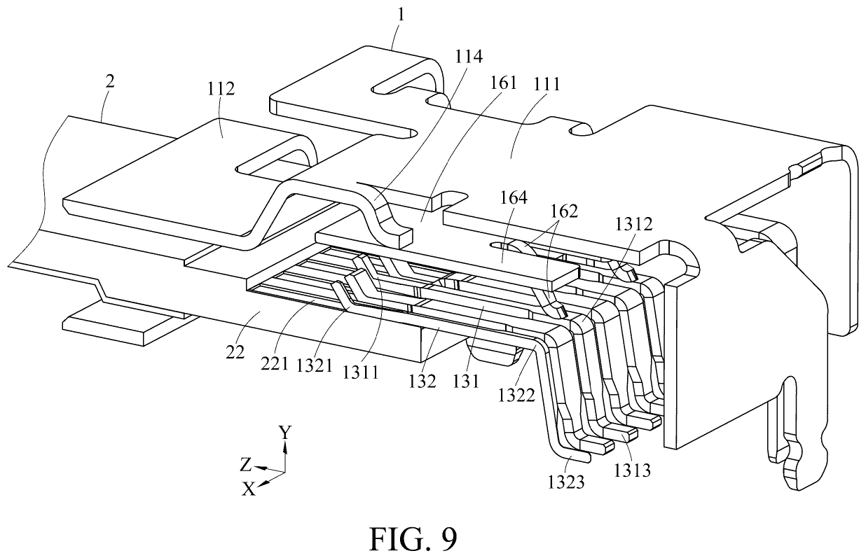

Please refer to FIG. 2 and FIG. 9. FIG. 9 illustrates an enlarged partial cross-sectional view of the board-end connector 1, showing the connection among the second elastic pieces 114, the conductive body 16, and the terminal module 13. In FIG. 9, the insulated housing 12 and the terminal base 15 are not shown. The main body 161 of the conductive body 16 is between the terminal module 13 and the cover plate 111, and the main body 161 is covered over the first contact portions 1311 and the second contact portions 1321. After the cable-end connector 2 is mated with the board-end connector 1, the first elastic pieces 113 at the frame opening portion 112 contact the grounding conduction portions 2112 on the flexible parallel cable 21 (as shown in FIG. 11), the second elastic pieces 114 at the cover plate 111 contact the main body 161 of the conductive body 16, and each of the third elastic pieces 162 is connected to the first body portion 1312 of the corresponding one of the ground terminals 131.

Please refer to FIG. 2 and FIG. 11. FIG. 11 illustrates a schematic view showing the grounding condition of the connector assembly, where the bolded dashed line indicates the grounding path G. In the case that the cable-end connector 2 is mated with the board-end connector 1, when the plug 22 and the flexible parallel cable 21 of the cable-end connector 2 are inserted into the receiving cavity 120 through the insertion opening 121, each of the grounding conduction portions 2112 contacts the corresponding one of the first elastic pieces 113 to allow an electrical connection among the flexible parallel cable 21, the outer shell 11, the conductive body 16, and the ground terminals 131 to be established. The noises on the flexible parallel cable 21 are transmitted to the first elastic pieces 113 through the grounding conduction portions 2112, some of the noises pass through the outer shell 11 to contact the circuit board 200 and thus can be guided outwards, and rest of the noises pass through the cover plate 111 and flow to the main body 161 of the conductive body 16 through the second elastic pieces 114. As for the noises passing through the conductive body 16, some of the noises are directly guided to the circuit board 200 through the legs 163, and the rest of the noises flow to the ground terminals 131 through the third elastic pieces 162 and flow to the circuit board 200 through the first body portions 1312 and the first tail portions 1313. Therefore, according to some embodiments, through the configuration of the first elastic pieces 131, the second elastic pieces 132, and the conductive body 16, a complete loop for grounding can be formed effectively, thereby ensuring that the noises can be grounded properly. Moreover, the conductive body 16 can effectively prevents signal interferences.

According to some embodiments of the instant disclosure, through the structural configuration among the grounding conduction portions of the flexible parallel cable, the first elastic pieces and the second elastic pieces of the outer shell, the ground terminals, and the conductive body, a complete loop for grounding can be formed effectively. Therefore, when the plug and the flexible parallel cable of the cable-end connector are inserted into the receiving cavity through the insertion opening, each of the grounding conduction portions contacts a corresponding one of the first elastic pieces to allow an electrical connection among the flexible parallel cable, the outer shell, the conductive body, and the ground terminals to be established. Accordingly, the complete loop for grounding can ensure the noises to be grounded properly. Moreover, the conductive body can effectively prevents signal interferences.

While the instant disclosure has been described by the way of example and in terms of the preferred embodiments, it is to be understood that the invention need not be limited to the disclosed embodiments. On the contrary, it is intended to cover various modifications and similar arrangements included within the spirit and scope of the appended claims, the scope of which should be accorded the broadest interpretation so as to encompass all such modifications and similar structures.

What is claimed is:

1. A connector assembly, comprising:
a board-end connector comprising:
an outer shell, comprising a cover plate and a frame opening portion at one side of the cover plate, wherein the outer shell has a plurality of first elastic pieces and a plurality of second elastic pieces, the first elastic pieces extend from two sides of the frame opening portion toward an interior of the frame opening portion, and the second elastic pieces extend from the cover plate toward an interior of the cover plate;
an insulated housing in the outer shell, wherein the insulated housing has a receiving cavity and an insertion opening in communication with the receiving cavity and corresponding to the frame opening portion, a surface of the insulated housing has a plurality of through holes for receiving the second elastic pieces;
a terminal module in the receiving cavity of the insulated housing, wherein the terminal module comprises a plurality of ground terminals and a plurality of pairs of signal terminals arranged as a single row along an axial line; and
a conductive body comprising a main body and a plurality of third elastic pieces, wherein the main body is in the receiving cavity of the insulated housing and connected to the second elastic pieces, and each of the third elastic pieces extends outwards from the main body and is connected to a corresponding one of the ground terminals; and
a cable-end connector comprising a flexible parallel cable and a plug at one end of the flexible parallel cable, wherein two surfaces of the flexible parallel cable comprise a plurality of grounding conduction portions;
wherein when the plug and the flexible parallel cable of the cable-end connector are inserted into the receiving cavity through the insertion opening, each of the grounding conduction portions contacts a corresponding one of the first elastic pieces to allow an electrical connection among the flexible parallel cable, the outer shell, the conductive body, and the ground terminals to be established.

2. The connector assembly according to claim 1, wherein each of the ground terminals comprises a first contact portion, a first body portion, and a first tail portion, the first contact portion extends from one of two ends of the first body portion, and the first tail portion extends from the other end of the first body portion; each of the signal terminals comprises a second contact portion, a second body portion, and a second tail portion, the second contact portion extends from one of two ends of the second body portion, and the second tail portion extends from the other end of the second body portion.

3. The connector assembly according to claim 2, wherein the terminal module comprises a terminal base formed with the first body portions of the ground terminals and the second body portions of the signal terminals, and the first tail portions of the ground terminals and the second tail portions of the signal terminals are exposed from the terminal base.

4. The connector assembly according to claim 3, wherein the terminal base comprises a plurality of protrusions combined with the signal terminals, each of the protrusions covers a corresponding one of the second body portions, and each of the first body portions is exposed from a side portion of a corresponding one of the protrusions and connected to a corresponding one of the third elastic pieces.

5. The connector assembly according to claim 4, wherein the conductive body comprises a plurality of shielding portions, each of the shielding portions leans against a corresponding one of the protrusions, and each of the third elastic pieces extends from a side portion of a corresponding one of the shielding portions to the side portion of the corresponding one of the protrusions and is connected to the corresponding one of the first body portions.

6. The connector assembly according to claim 2, wherein the main body of the conductive body is between the terminal module and the cover plate, and the main body is covered over the first contact portions and the second contact portions.

7. The connector assembly according to claim 1, wherein a skin of the flexible parallel cable comprises a shielding layer, the shielding layer has a plurality of non-insulated regions, and the grounding conduction portions are arranged on the non-insulated regions at the two surfaces of the flexible parallel cable.

8. The connector assembly according to claim 1, wherein each of the pairs of the signal terminals are between corresponding two of the ground terminals, one surface of the plug comprises a plurality of contacts, and the contacts are configured to be connected to the signal terminals and the ground terminals.

9. The connector assembly according to claim 1, wherein the number of the signal terminals and the ground terminals is 37, the number of the signal terminals is 24, and the number of the ground terminals is 13.

10. The connector assembly according to claim 8, wherein the flexible parallel cable of the cable-end connector is a flexible flat cable, each of the contacts is a flat terminal, a connection line between the contacts is defined as a first axial line, the contacts are arranged along the first axial line and spaced apart from each other, and the contacts at the surface of the plug are arranged into a single row.
